(19) United States
(12) Patent Application Publication
(10) Pub. No.: US 2017/0218951 A1
(43) Pub. Date: Aug. 3, 2017

(54) Fluid End Block for Well Stimulation Pump and Method of Remanufacturing the Same

(71) Applicant: Caterpillar Inc., Peoria, IL (US)

(72) Inventors: Curtis J. Graham, Peoria, IL (US); Daniel T. Cavanaugh, Chillicothe, IL (US)

(73) Assignee: Caterpillar Inc., Peoria, IL (US)

(21) Appl. No.: 15/012,522

(22) Filed: Feb. 1, 2016

(51) Int. Cl. F04B 53/16; B23P 6/04; B24C 1/00; B05D 1/02; F04B 19/22; F04B 53/10; F04B 53/14; E21B 43/26; F04B 7/04

(52) U.S. Cl. CPC F04B 53/166; E21B 43/26; B23P 6/04; B24C 1/00; F04B 7/04; F04B 19/22; F04B 53/10; F04B 53/14; B05D 1/02; E21B 43/267

(57) ABSTRACT

A method of remanufacturing a fluid end block of a well stimulation pump includes cleaning an interior surface of a body of the fluid end block. The interior surface defines a chamber, a plunger passage in communication with the chamber, an intake passage in fluid communication with the chamber, and a discharge passage in fluid communication with the chamber. The interior surface is made from a base material. The interior surface of the fluid end block is cold-worked to produce a compressive residual stress layer within the body. A coating layer made from a non-metallic material is applied to at least a portion of the interior surface of the body. The non-metallic material is different from the base material.

### TECHNICAL FIELD

This patent disclosure relates generally to well stimulation pump systems, and more particularly to fluid end blocks for a well stimulation pump system and methods for remanufacturing the same.

### BACKGROUND

Underground hydraulic fracturing can be performed to increase or stimulate the flow of hydrocarbon fluid from a well. To conduct a fracturing process, a fracturing fluid, which typically contains a propping material (also referred to as a “proppant”) dispersed in the fluid, is pumped at high pressure down the well-bore and into a hydrocarbon formation to split—or fracture—the rock formation along veins or planes extending from the well-bore. Once the desired fracture is formed, the fluid flow is reversed, and the liquid portion of the fracturing fluid is removed. The proppants remain in place to prop the fracture in an open condition, preventing the stresses within the hydrocarbon formation from causing the opening to collapse.

The propping material, such as silica sand, for example, is typically provided in particle form. The proppants support the fractures in open positions, yet remain permeable to hydrocarbon fluid flow since they form a packed bed of particles with interstitial void spaces defined therebetween that permit fluid flow therethrough. Fractures that are propped open with proppant clusters can thus serve as new formation drainage areas and flow conduits from the formation to the well bore, thereby providing increased hydrocarbon production from the well.

Plunger pumps are commonly used in the oil and gas industry as well stimulation pumps for hydraulic fracturing applications. Plunger pumps have a fluid end and a power end that drives the fluid end. The fluid end of a conventional well stimulation pump system frequently has a limited service life because it is prone to break down after a certain amount of “wet fatigue” pressure cycles. The fracturing fluid can be corrosive and cause the corrosion of the internal surfaces of the fluid end. The corroded surface creates stress risers. Wet fatigue involves a failure process where cracks can propagate from these stress risers as a function of the cyclic stress until the cracks are significant enough to cause the failure of the fluid end.

U.S. Pat. No. 8,359,967 is entitled, “Fluid End Reinforced with a Composite Material.” The '967 patent is directed to a fluid end for a reciprocating pump that includes a base material that is less subject to abrasion, corrosion, erosion and/or wet fatigue than conventional fluid end materials, such as carbon steel, and a reinforcing composite material for adding stress resistance and reduced weight to the fluid end.

There is a continued need in the art to provide additional solutions to extend the service life and/or facilitate the maintenance of well stimulation pump systems. For example, there is a continued need for remanufacturing techniques that produce a remanufactured fluid end block that is restored to a satisfactory operating condition for a renewed useful life of the remanufactured part with improved corrosion resistance.

It will be appreciated that this background description has been created by the inventors to aid the reader, and is not to be taken as an indication that any of the indicated problems were themselves appreciated in the art. While the described principles can, in some aspects and embodiments, alleviate the problems inherent in other systems, it will be appreciated that the scope of the protected innovation is defined by the attached claims, and not by the ability of any disclosed feature to solve any specific problem noted herein.

### SUMMARY

In embodiments, the present disclosure describes a fluid end block for a well stimulation pump. The fluid end block includes a body and a coating layer of a non-metallic material.

The body includes an interior surface which defines a chamber, a plunger passage in communication with the chamber, an intake passage in fluid communication with the chamber, and a discharge passage in fluid communication with the chamber. The interior surface is made from a base material. The body includes a compressive residual stress layer.

The coating layer is applied to at least a portion of the interior surface of the body. The coating layer is made from a non-metallic material which is different from the base material.

In another embodiment, a fluid end assembly for a well stimulation pump includes a body, an intake valve, a discharge valve, a plunger, and a coating layer of a non-metallic material. The body includes an interior surface which defines a chamber, a plunger passage in communication with the chamber, an intake passage in fluid communication with the chamber, and a discharge passage in fluid communication with the chamber. The interior surface is made from a base material. The body includes a compressive residual stress layer.

The intake valve is disposed within the intake passage of the body. The intake valve is configured to selectively move between an intake closed position, in which the intake valve occludes the intake passage, and an intake open position, in which the intake valve permits fluid flow therethrough.

The discharge valve is disposed within the discharge passage of the body. The discharge valve is configured to selectively move between a discharge closed position, in which the discharge valve occludes the discharge passage, and a discharge open position, in which the discharge valve permits fluid flow therethrough.

The plunger is disposed within the plunger passage such that the plunger is reciprocally movable over a range of travel including a suction stroke and a discharge stroke. The plunger draws the intake valve to the intake open position to open the intake passage during the suction stroke. The plunger moves the intake valve to the intake closed position to occlude the intake passage and moves the discharge valve to the discharge open position during the discharge stroke.

The coating layer is applied to at least a portion of the interior surface of the body. The coating layer is made from a non-metallic material which is different from the base material.

In yet another embodiment, a method of remanufacturing a fluid end block of a well stimulation pump is described. An interior surface of a body of the fluid end block is cleaned. The interior surface is made from a base material. The interior surface defines a chamber, a plunger passage in communication with the chamber, an intake passage in fluid communication with the chamber, and a discharge passage in fluid communication with the chamber.

The interior surface of the fluid end block is cold-worked to produce a compressive residual stress layer within the body. A coating layer made from a non-metallic material is applied to at least a portion of the interior surface of the body. The non-metallic material is different from the base material.

Further and alternative aspects and features of the disclosed principles will be appreciated from the following detailed description and the accompanying drawings. As will be appreciated, the devices, systems, and methods disclosed herein are capable of being carried out in other and different embodiments, and capable of being modified in various respects. Accordingly, it is to be understood that both the foregoing general description and the following detailed description are exemplary and explanatory only and do not restrict the scope of the appended claims.

### BRIEF DESCRIPTION OF THE DRAWINGS

FIG. 1 is a schematic side elevational view of an embodiment of a well stimulation pump system constructed in accordance with principles of the present disclosure.

FIG. 2 is a schematic top plan view of the well stimulation pump system of FIG. 1.

FIG. 3 is a schematic front elevational view of the well stimulation pump system of FIG. 1.

FIG. 4 is a cross-sectional view, taken along line IV-IV in FIG. 3, of the well stimulation pump system of FIG. 1.

FIG. 5 is a perspective view of a fluid end block of the well stimulation pump system of FIG. 1, the fluid end block being constructed in accordance with principles of the present disclosure.

FIG. 6 is a cross-sectional view, taken along line V-V in FIG. 5, of the fluid end block of FIG. 5.

FIG. 7 is a flowchart illustrating steps of an embodiment of a method of remanufacturing a fluid end block for a well stimulation pump system following principles of the present disclosure.

It should be understood that the drawings are not necessarily to scale and that the disclosed embodiments are sometimes illustrated diagrammatically and in partial views. In certain instances, details which are not necessary for an understanding of this disclosure or which render other details difficult to perceive may have been omitted. It should be understood, of course, that this disclosure is not limited to the particular embodiments illustrated herein.

### DETAILED DESCRIPTION

Embodiments of well stimulation pump systems, fluid end block assemblies, and methods of remanufacturing fluid end blocks are disclosed herein. In embodiments, a method of remanufacturing a fluid end block for a well stimulation pump system following principles of the present disclosure can include applying a coating layer of a non-metallic material upon an interior surface of the fluid end block. In embodiments, the non-metallic material from which the coating layer is made can have a corrosion resistance that is greater than that of the base material from which the fluid end block is made.

In embodiments, the coating layer of non-metallic material (e.g., an epoxy, an elastomer such as rubber, etc.) can be applied via any suitable technique. For example, in embodiments, the coating layer of non-metallic material can be applied to the interior surface of the fluid end block by being sprayed upon the interior surface of the fluid end block. In other embodiments, the coating layer of non-metallic material can be in the form of a solid liner that is separately made and is applied to the interior surface by being inserted into the fluid end block and placed in contacting relationship with the interior surface.

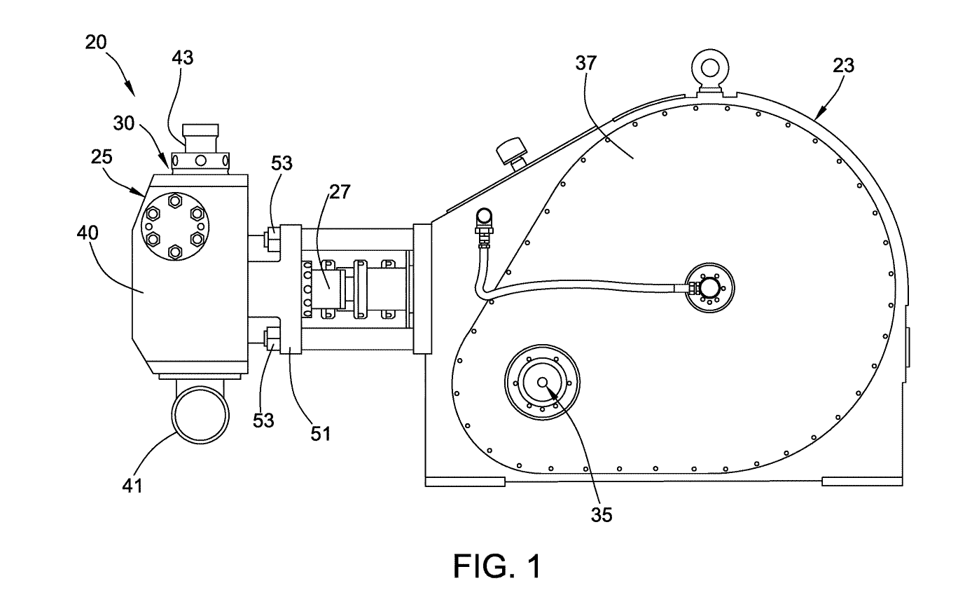

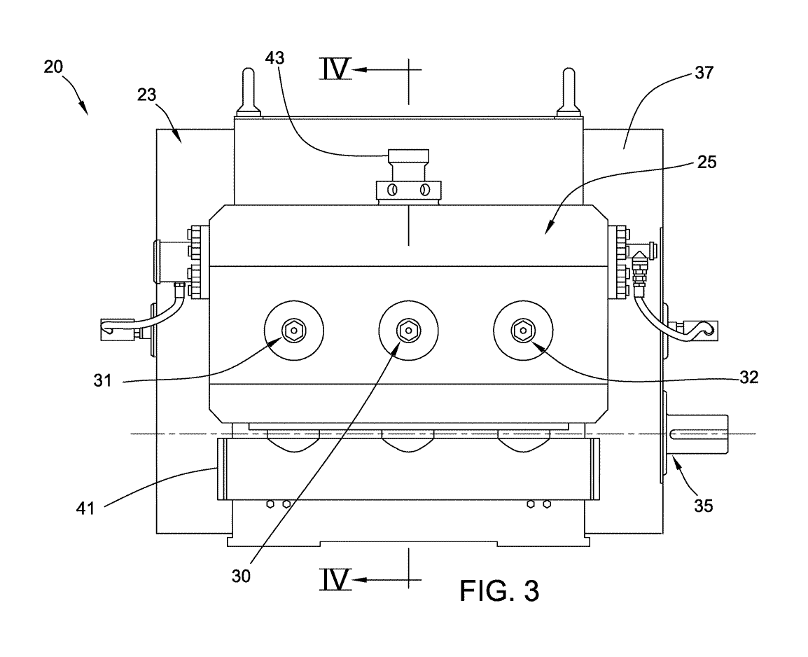

Turning now to the Figures, there is shown in FIGS. 1-3 an exemplary embodiment of a well stimulation pump system 20 constructed according to principles of the present disclosure. The well stimulation pump system 20 can be used to pump high pressure fracturing fluid into a well for the recovery of oil and/or gas contained within a subterranean hydrocarbon formation.

The well stimulation pump system 20 includes a power end 23 and a fluid end 25, which is coupled to the power end 23. The well stimulation pump system 20 illustrated in FIG. 1 is in the form of a triplex pump that includes three plungers 27. Accordingly, the fluid end includes three pumping chamber assemblies 30, 31, 32. It will be understood by one skilled in the art that, in other embodiments, a well stimulation pump system constructed according to principles of the present disclosure can have different forms.

The power end 23 includes a motor assembly 35 disposed within a housing 37. The motor assembly 35 is configured to selectively drive the plungers 27. The motor assembly 35 can be configured to reciprocally move the plungers 27 to pressurize a working fluid (e.g., a fracking fluid) in the fluid end 25. In embodiments, the motor assembly 35 can have any suitable arrangement. In embodiments, the motor assembly 35 includes a suitable engine, such as, a diesel engine, for example, and a transmission configured to convert the rotational movement of the engine to reciprocal axial movement of the plungers 27. In embodiments, a well stimulation pump system constructed according to principles of the present disclosure can include any suitable power end, as will be understood by one skilled in the art.

In embodiments, the fluid end 25 comprises at least one pump container configured to hold a supply of fluid that is drawn therein by the movement of a respective plunger 27 over a suction stroke and to discharge pressurized fluid therefrom that is pressurized by the reciprocal movement of the plungers over a power stroke. The fluid end 25 can include a fluid end block 40, an inlet conduit 41, and a high-pressure outlet coupling 43.

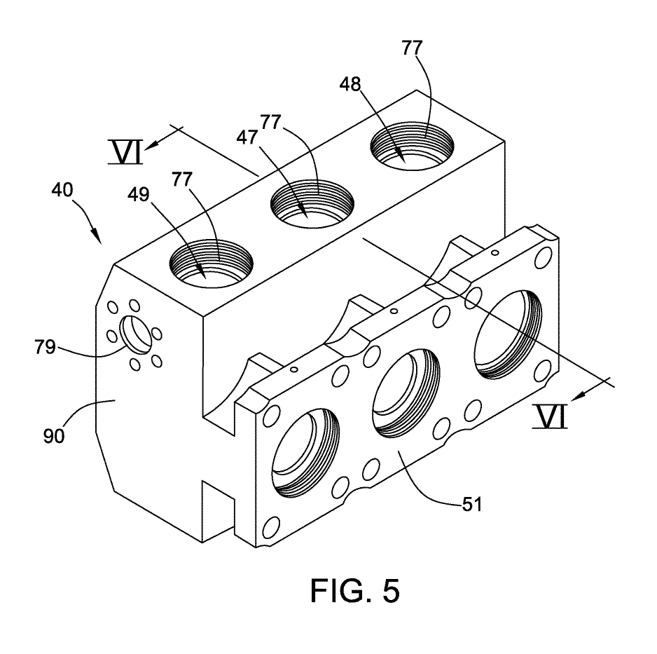

In embodiments, the fluid end block 40 defines one or more internal pumping cavities each configured to interact with a respective plunger 27 to draw a working fluid (e.g., fracturing fluid) therein and to discharge pressurized working fluid therefrom. In the illustrated embodiment, the fluid end block 40 defines three pumping cavities 47, 48, 49 (see FIG. 5) which respectively house the three pumping chamber assemblies 30, 31, 32 therein. The fluid end block 40 includes a mounting flange 51 which can be disposed proximate the power end 23. The mounting flange 51 can be configured to receive a plurality of fasteners 53 therethrough for connecting the fluid end 25 to the power end 23. In embodiments, other suitable connection techniques can be used to secure the fluid end 25 to the power end 23.

Referring to FIGS. 1, 3, and 5, the inlet conduit 41 is in fluid communication with each of the pumping cavities 47, 48, 49 of the fluid end block 40. The inlet conduit 41 can be placed in fluid communication with a supply of fracturing fluid for selective delivery to each pumping cavity of the fluid end block 40 during operation of the well stimulation pump system 20. The inlet conduit 41 as shown in FIG. 1 is in the form of a cylindrical tube which is in fluid communication with all three pumping cavities 47, 48, 49 defined by the fluid end block 40 in the illustrated embodiment. In other embodiments, the inlet conduit 41 can have a different configuration as will be appreciated by one skilled in the art.

Referring to FIGS. 1-3, the high-pressure outlet coupling 43 is mounted to the center pumping chamber assembly 30. The high-pressure outlet coupling 43 is configured to dispense pressurized working fluid (e.g., pressurized fracturing fluid) from the fluid end block 40 of the fluid end 25 for delivery to a working site. For example, in embodiment, a conduit (not shown) can be coupled to the high-pressure outlet coupling 43 such that the conduit is configured to deliver high-pressure fracturing fluid to a subterranean location via a well. In embodiments, the high-pressure outlet coupling 43 can have any suitable configuration (e.g., either a male connector or a female connector).

During use, the fluid end 25 receives a working fluid (e.g., a fracturing fluid) at a low pressure and discharges it at a high pressure. The pressurization of the fracturing fluid within the fluid end 25 is caused by the plungers 27 as directed by the motor assembly 35 of the power end 23. The plungers 27 move away from the fluid end 25 during a suction stroke to draw low-pressure fluid through the inlet conduit 41 into the pumping cavities 47, 48, 49 of the fluid end 25 from the supply of fracturing fluid, and the plungers 27 move toward the fluid end 25 during a power stroke to pressurize the fluid within the fluid end 25 and to discharge the pressurized fracturing fluid from the fluid end 25 out through the high-pressure outlet coupling 43.

It should be understood that, in other embodiments, the well stimulation pump system 20 can have different forms. For example, in other embodiments, a well stimulation pump system constructed according to principles of the present disclosure can be in the form of a different type of multiplex reciprocating pump. For example, in other embodiments, the well stimulation pump system constructed according to principles of the present disclosure can be in the form of a quintuplex pump that includes five plungers and a fluid end with five pumping chamber assemblies.

In addition, in still other embodiments, a well stimulation pump system constructed according to principles of the present disclosure can include a fluid end that is in the form of a monoblock fluid end that includes a single pumping chamber for use with a single plunger. In still other embodiments, the fluid end can include a plurality of modular fluid end blocks that are connected together using any suitable technique (e.g., a plurality of threaded fasteners and tie rods). Each modular fluid end block can include at least one pumping chamber and a corresponding number of plungers can be provided.

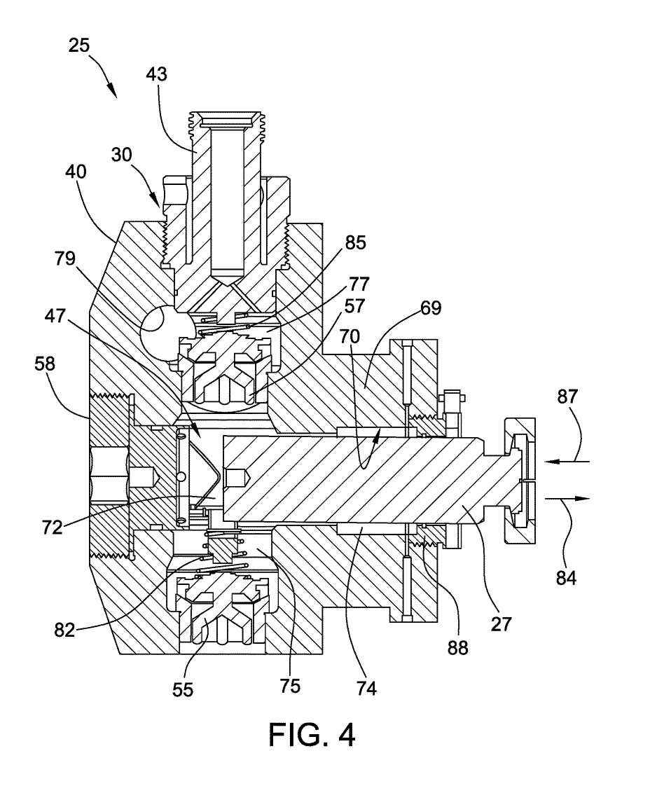

Referring to FIG. 4, the center pumping chamber assembly 30 of the fluid end 25 is shown disposed in the center pumping cavity 47 defined by the fluid end block 40. The two side pumping chamber assemblies 31, 32 of the fluid end 25 are substantially identical to the one shown in FIG. 4 and are disposed in the two side pumping cavities 48, 49, respectively. It should be understood, therefore, that the description of one pumping chamber assembly is applicable to the other pumping chamber assemblies, as well. The center pumping chamber assembly 30 includes an intake valve 55, a discharge valve 57, the plunger 27, a plug 58, and the high-pressure outlet coupling 43.

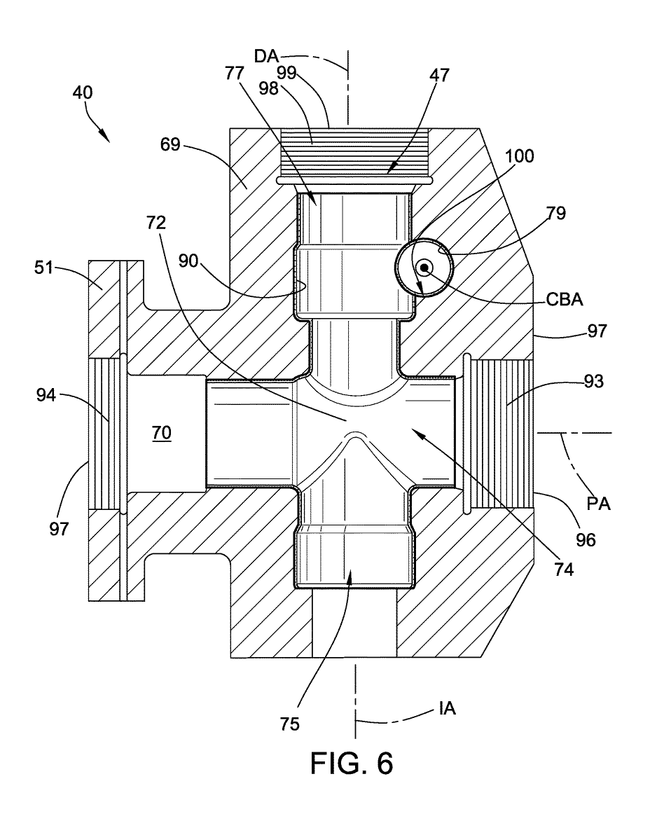

Referring to FIGS. 4 and 6, the fluid end block 40 includes a body 69 having an interior surface 70 which defines a chamber 72, a plunger passage 74 in communication with the chamber, an intake passage 75 in fluid communication with the chamber, and a discharge passage 77 in fluid communication with the chamber 72. The chamber 72 is configured to receive fracturing fluid which is drawn in from the intake passage 75 for the plunger 27 to effect high pressurization of the fracturing fluid in the chamber 72. The pressurized fracturing fluid can be discharged from the fluid end 25 through the discharge passage 77. Referring to FIG. 4, the pumping chamber assembly 30 of the fluid end 25 is configured to cyclically draw working fluid into the chamber 72, pressurize the working fluid in the chamber 72, and discharge it therefrom to be delivered to a worksite, such as a subterranean hydrocarbon formation, for example.

Referring to FIGS. 4-6, the fluid end block 40 defines a common cross-bore discharge passage 79 which is in fluid communication with the discharge passage 77 of each of the pumping cavities 47, 48, 49 such that the pressurized fracturing fluid flowing through any one of the discharge passages 77 of the fluid end block 40 can be diverted to the high-pressure outlet coupling 43 positioned in the discharge passage 77 of the center pumping cavity 47.

Referring to FIG. 4, the intake valve 55 is disposed within the intake passage 75 of the fluid end block 40. The intake valve 55 is configured to selectively move between an intake closed position (shown in FIG. 4), in which the intake valve 55 occludes the intake passage 75, and an intake open position (upwardly displaced from the position shown in FIG. 4), in which the intake valve permits fluid flow therethrough. An intake biasing mechanism 82, such as a spring, for example, can be provided to bias the intake valve 55 outwardly from the chamber 72 to the intake closed position.

The intake valve 55 is configured to selectively move to the open position in response to a negative pressure differential within the chamber 72 to allow working fluid to enter the chamber 72 through the intake valve 55 when the pressure in the chamber 72 is sufficiently less than on the other side of the intake valve 55. The negative pressure within the chamber 72 can be created by the plunger 27 moving outwardly relative to the chamber 72 in a suction direction 84. Once the negative pressure differential between the chamber 72 and the intake passage 75 on the outside of the intake valve 55 is at a sufficient level to overcome the biasing force of the intake biasing mechanism 82, the intake valve 55 can be drawn inwardly in response to the negative pressure within the chamber to move the intake valve 55 to the intake open position to open the intake passage 75. In embodiments, the threshold negative pressure within the chamber 72 for opening the intake valve 55 can be varied.

The discharge valve 57 is disposed within the discharge passage 77 of the fluid end block 40. The discharge valve 57 is configured to selectively move between a discharge closed position (shown in FIG. 4), in which the discharge valve 57 occludes the discharge passage 77, and a discharge open position (downwardly displaced from the position shown in FIG. 4), in which the discharge valve 57 permits fluid flow therethrough. A discharge biasing mechanism 85, such as a spring, for example, can be provided to bias the discharge valve 57 inwardly toward the chamber 72 to the discharge closed position which keeps the discharge passage 77 occluded.

The discharge valve 57 is configured to selectively move to the open position in response to a positive pressure differential within the chamber 72 to allow pressurized working fluid to leave the chamber 72 through the discharge valve 57 when the pressure in the chamber 72 is sufficiently greater than on the other side of the discharge valve 57. The positive pressure within the chamber 72 can be created by the plunger 27 moving inwardly relative to the chamber 72 in a power direction 87, which is in opposing relationship to the suction direction 84. Once the positive pressure differential between the chamber 72 and the discharge passage 77 on the outside of the discharge valve 57 is at a sufficient level to overcome the biasing force of the discharge biasing mechanism 85, the discharge valve 57 can be urged outwardly in response to the positive pressure within the chamber 72 to move the discharge valve 57 outwardly to the discharge open position. In embodiments, the threshold positive pressure within the chamber 72 for opening the discharge valve 57 can be varied.

The plunger 27 is disposed within the plunger passage 74 such that the plunger 27 is reciprocally movable over a range of travel including a suction stroke and a discharge stroke. The plug 58 is threadedly engaged with the interior surface 70 of the fluid end block 40 at an end of the plunger passage 74 opposite the plunger 27. The plug 58 can be removed from the fluid end block 40 to provide selective access to the chamber 72. In embodiments, the plug 58 can have a different configuration and can be mounted to the fluid end block 40 using a different technique, as will be appreciated by one skilled in the art.

The plunger 27 can be sealingly engaged with the fluid end block 40 of the fluid end 25 to substantially prevent working fluid from flowing out of the chamber 72 past the plunger 27 through the plunger passage 74. In embodiments, one or more seal members 88 can be provided to effect the sealing relationship. In embodiments, both the seal member 88 and the plug 58 can have a suitable o-ring interposed between an exterior surface thereof and the interior surface 70 to provide a sealed interface.

In use, the plunger 27 can move outwardly relative to the chamber 72 in the suction direction 84 to effect negative pressurization in the chamber to draw the intake valve 55 to the intake open position to open the intake passage 75 during the suction stroke. A source of fracturing fluid can be in fluid communication with the intake passage 75 via the inlet conduit 41. The source of fracturing fluid can be at a relatively low pressure that is not sufficient to overcome the biasing force of the intake biasing mechanism 82, but is operable to propel the source of fracturing fluid into the chamber 72 once the plunger 27 draws the intake valve 55 to the intake open position. The discharge valve 57 remains in the discharge closed position during the suction stroke.

After the suction stroke is completed, the plunger 27 can move inwardly relative to the chamber in the power direction 87 during the power stroke to effect positive pressurization in the chamber to pressurize the fracturing fluid in the chamber. In response to the positive pressure generated within the chamber, the intake biasing mechanism 82 is allowed to urge the intake valve 55 back to the intake closed position to occlude the intake passage 75, and the discharge valve 57 moves outwardly to the discharge open position such that the pressurized fracturing fluid in the chamber 72 flows through the discharge valve 57 through the discharge passage 77 to the well bore site. During the power stroke, the intake valve 55 remains in the intake closed position.

The plunger 27 can reciprocally move over the suction stroke and the power stroke to periodically draw fracturing fluid through the intake passage 75 into the chamber 72 from the source of fracturing fluid and to discharge fracturing fluid from the chamber 72 into the discharge passage 77 for delivery to the well bore site. With the continued reciprocal movement of the plunger 27, the fracturing fluid is alternately drawn into the chamber 72 and discharged therefrom at relatively higher pressure.

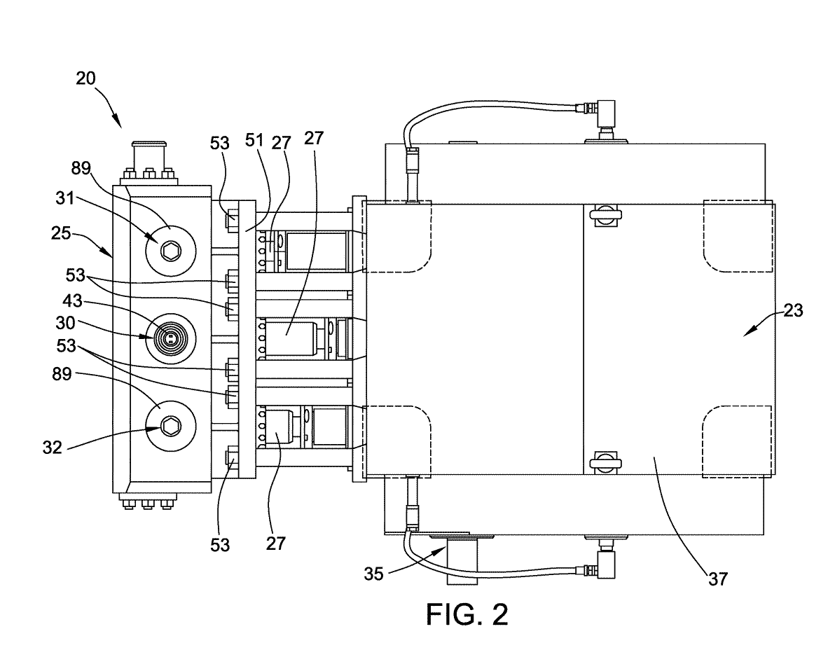

The plungers 27 associated with the side pumping chamber assemblies 31, 32 can operate in a similar manner. In embodiments, the well stimulation pump system 20 can be configured such that each plunger 27 of the three pumping chamber assemblies 30, 31, 32 reciprocally moves such that it is out of phase with the other two plungers 27. The pressurized fracturing fluid discharged from each of the side pumping chamber assemblies 31, 32 can be fed to the center pumping chamber assembly 30 via the common cross-bore discharge passage 79 which is in fluid communication with the discharge passage 77 of each of the pumping chamber assemblies 30, 31, 32. The discharge passage 77 of each of the side pumping chamber assemblies 31, 32 can have a plug 89 threadedly secured thereto (see FIG. 2) to direct the pressurized fracturing fluid from the side pumping chamber assemblies 31, 32 into the common cross-bore discharge passage 79 and out the high-pressure outlet coupling 43 secured in the discharge passage 77 of the center pumping chamber assembly 30 to the well bore site.

Referring to FIGS. 5 and 6, the fluid end block 40 of the well stimulation pump system 20 is shown. The fluid end block 40 includes the body 69 and a coating layer 90 of a non-metallic material applied to the body 69.

Referring to FIG. 5, the body 69 substantially defines the pumping cavities 47, 48, 49 and the common cross-bore discharge passage 79. In embodiments, at least one cover plate can be secured to the body 69 to close off a respective end of the common cross-bore discharge passage 79. The body 69 can also include the mounting flange 51.

In embodiments, the body 69 can be made using any suitable technique, as will be appreciated by one skilled in the art. For example, in embodiments, the body 69 can have a unitary construction. In embodiments, a body blank can be made from a piece of material and then machined to final size and configuration to form the body 69. For example, in embodiments, the body 69 can comprise a high-strength steel forging, which can be machined to help define the pumping cavities 47, 48, 49 and the common cross-bore discharge passage 79. In embodiments, the body blank can be formed from multiple pieces that are connected together (such as by welding, for example) to form an integral body blank.

In other embodiments, the body 69 can have a multi-piece construction. For example, in embodiments, the body 69 can include a block portion that defines at least one pumping passage with a plunger bore and a fluid bore and one or more sleeves and/or cartridges which are mounted inside one of the plunger bore and the fluid bore of the block portion to define a pumping cavity (such as one similar to that of the body 69). In embodiments, each sleeve and/or cartridge can be mounted to the block portion using any suitable technique, as will be appreciated by one skilled in the art. In embodiments, at least one sleeve and/or cartridge defines at least one of the chamber, the plunger passage, the intake passage, and the discharge passage. In embodiments where the body has a multi-piece construction, the piece or pieces having the portion of the interior surface that will receive the coating layer of non-metallic material can have the coating layer applied thereto either before or after the assembly of the pieces that form the body.

Referring to FIG. 6, the plunger passage 74 of the fluid end block 40 extends along a plunger axis PA. The intake passage 75 extends along an intake axis IA, and the discharge passage 77 extends along a discharge axis DA. In the illustrated embodiment, the intake axis IA and the discharge axis DA are each substantially perpendicular to the plunger axis PA. The intake axis IA and the discharge axis DA are substantially aligned with each other. The common cross-bore discharge passage 79 extends along a cross bore discharge axis CBA that is substantially perpendicular to each of the plunger axis PA, the intake axis IA, and the discharge axis DA.

In the illustrated embodiment, the plunger passage 74 is in the form of a through-bore that extends from a front face 92 of the body 69 to the mounting flange 51. The intake passage 75 and the discharge passage 77 are also in the form of a through bore such that the intake passage 75 and the discharge passage 77 are aligned. The through bores of the plunger passage 74 along the plunger axis PA and the intake and discharge passages 75, 77, which are aligned along the perpendicular intake axis IA and discharge axis DA, intersect each other at the chamber 72.

In embodiments, the plunger passage 74, the intake passage 75, and/or the discharge passage 77 can have a different configuration. For example, in embodiments, the body 69 of the fluid end block 40 can define passages that form a T-shape, a Y-shape, an in-line configuration, or other configurations, as will be appreciated by one skilled in the art.

The interior surface 70 of the body 69 is made from a base material. In embodiments, the base material can be any suitable material, such as a metal alloy. For example, in embodiments, the base material of the body 69 comprises a carbon steel.

In embodiments, the body 69 can include a compressive residual stress layer. In embodiments, the compressive residual stress layer can be made using any suitable technique as will be appreciated by one skilled in the art. For example, in embodiments, the interior surface 70 of the body 69 of the fluid end block 40 can be cold-worked to produce the compressive residual stress layer within the body 69. In embodiments, the interior surface 70 can be cold-worked using any suitable technique, as will be appreciated by one skilled in the art. For example, in embodiments, shot peening can be used to cold-work the interior surface of the body.

In embodiments, the coating layer 90 of a non-metallic material is applied to at least a portion of the interior surface 70 of the body 69. In embodiments, the interior surface 70 of the body 69 of the fluid end block includes at least one threaded portion and a non-threaded portion. In embodiments, the coating layer 90 substantially covers the non-threaded portion of the interior surface 70 of the body 69 that defines the chamber 72, the plunger passage 74, the intake passage 75, and the discharge passage 77.

In the illustrated embodiment, the interior surface 70 of the body 69 includes first and second plunger end threaded portions 93, 94, disposed at respective openings 96, 97 of the plunger passage 74 and a discharge coupling threaded portion 98 disposed at an outlet opening 99 of the discharge passage 77. The first and second plunger end threaded portions 93, 94 are configured to threadedly secure the seal member 88 and the plug 58 to the body 69. The discharge coupling threaded portion 98 is configured to threadedly secure the high-pressure outlet coupling 43 to the body 69. In the illustrated embodiment, the coating layer 90 completely covers the chamber 72. The coating layer 90 also covers the inner portions of the plunger passage 74, the intake passage 75, and the discharge passage 77. In the illustrated embodiment, the coating layer 90 is offset from each of the first and second plunger end threaded portions 93, 94 and the discharge coupling threaded portion 98. In embodiments, the coating layer 90 does not cover any of the threaded portions of the interior surface of the body of the fluid end block.

In embodiments, the coating layer 90 can also be applied to a cross-bore interior surface 100 that defines the common cross-bore discharge passage 79. In embodiments, the coating layer 90 can substantially cover the cross-bore interior surface 100.

In embodiments, the coating layer 90 can be made from any suitable non-metallic material that has a desired property. For example, in embodiments, the coating layer 90 is made from a non-metallic material that has a corrosion resistance that is better than that of the base material from which the interior surface 70 of the body 69 is made. In embodiments, the coating layer 90 is made from a non-metallic material that comprises at least one of an epoxy and an elastomeric material. In embodiments, the coating layer 90 is made from a non-metallic material which is different from the base material of the body 69.

In embodiments, the coating layer 90 of non-metallic material (e.g., an epoxy, an elastomer such as rubber, etc.) can be applied via any suitable technique. For example, in embodiments, the coating layer 90 of non-metallic material can be applied to the interior surface 70 of the body 69 of the fluid end block 40 by being sprayed upon the interior surface 70 via a nozzle applicator. In other embodiments, the coating layer 90 of non-metallic material can be in the form of a solid liner that is separately made and is applied to the interior surface by being inserted into the body 69 of the fluid end block 40 and placed in contacting relationship with the interior surface 70.

Although the illustrated embodiment of FIGS. 1-6 depicts a fluid end suitable for use in a multiplex well stimulation pump system, this is only exemplary. It will be apparent to one skilled in the art that various aspects of the disclosed principles relating to fluid end configurations can be used with a variety of different types of systems and applications. Accordingly, one skilled in the art will understand that, in other embodiments, a fluid end for a well stimulation pump system constructed according to principles of the present disclosure can have different forms and can be utilized in other high pressure pumping applications to alleviate issues relating to operating pressures, mechanical stresses, erosion and/or corrosion of internal passages.

In embodiments of a method of remanufacturing a fluid end block following principles of the present disclosure, the fluid end block is remanufactured such that at least a portion of the interior surface of the fluid end block has a coating layer applied thereto which is made from a non-metallic material (such as a suitable elastomer or epoxy, for example). In embodiments, a method of remanufacturing a fluid end block following principles of the present disclosure can be used to make any embodiment of a fluid end block according to principles discussed herein.

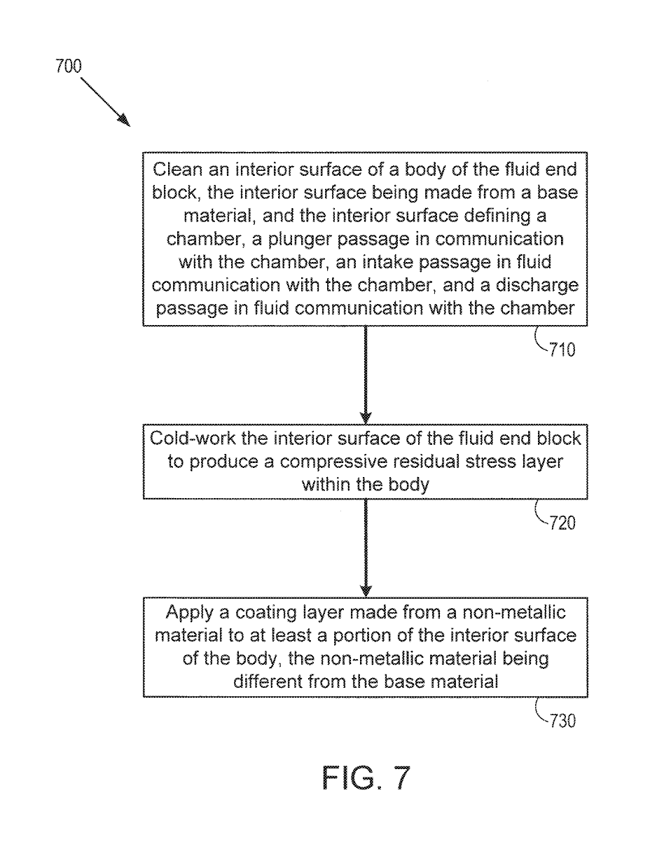

Referring to FIG. 7, steps of an embodiment of a method 700 of remanufacturing a fluid end block of a well stimulation pump following principles of the present disclosure are shown. An interior surface of a body of the fluid end block is cleaned (step 710). The interior surface is made from a base material. The interior surface defines a chamber, a plunger passage in communication with the chamber, an intake passage in fluid communication with the chamber, and a discharge passage in fluid communication with the chamber.

The interior surface of the fluid end block is cold-worked to produce a compressive residual stress layer within the body (step 720). A coating layer made from a non-metallic material is applied to at least a portion of the interior surface of the body (step 730). The non-metallic material is different from the base material.

In embodiments, the plunger passage of the fluid end block extends along a plunger axis. The intake passage extends along an intake axis, and the discharge passage extends along a discharge axis. Each of the intake axis and the discharge axis is substantially perpendicular to the plunger axis. In embodiments, the body is made substantially from the base material.

In embodiments of a method following principles of the present disclosure, a used fluid end block is inspected to verify that it is in a condition that would permit the remanufacturing process to be applied to it to produce a satisfactory result. For example, in embodiments, inspecting the used fluid end block includes determining whether the fluid end block suffers from mechanical defects or other damage that would still disqualify it from service even after undergoing the remanufacturing method 700.

In embodiments, the fluid end block is cleaned to remove oil, grease, dirt, and other foreign material. In embodiments, the fluid end block is cleaned no more than a predetermined amount of time before the coating layer is applied thereto (e.g., no more than five hours prior to coating).

In embodiments, any suitable technique can be used to clean the interior surface of the body. For example, in embodiments, the interior surface of the body can be cleaned by abrasive blasting the interior surface with a stream of abrasive media. In embodiments, any suitable blast media can be used. For example, in embodiments, the stream of abrasive media comprises glass beads.

In embodiments of a method following principles of the present disclosure, the method can include cleaning and otherwise removing corrosion, impurity buildups, and contamination on the interior surface of the fluid end block. In embodiments, the fluid end block undergoes various surface preparation steps to ready the fluid end block to receive the coating layer of a non-metallic material. For example, in embodiments, any cracks in the body can be repaired before having the coating layer applied thereto.

In embodiments, any suitable technique can be sued to repair a crack in the body. For example, in embodiments, the crack can be repaired by welding the body. In at least some of such embodiments, the body can be machines to be within a tolerance range of a dimensional specification. For example, in embodiments, the weld area can be machined to bring the portion of the fluid end block containing the weld area to within a tolerance range for at least one dimensional specification. In embodiments, the fluid end block can be machined to remove a worn portion of the fluid end block that would interfere with applying the coating layer to the interior surface, such as corroded areas or defects present in the fluid end block.

In embodiments, the interior surface can be cold-worked using any suitable technique, as will be appreciated by one skilled in the art. For example, in embodiments, cold working the interior surface of the body includes shot peening the interior surface.

In other embodiments, the fluid end block can be cold-worked via an autofrettage process, which involves a mechanical pre-treatment of the fluid end block in order to induce residual stresses at the internal free surfaces, i.e., the surfaces that are exposed to the fracturing slurry. During autofrettage, the interior surface of the fluid end block can be exposed to high hydrostatic pressure that is sufficient to cause plastic yielding of the interior surface. The deformation of the interior surface can be elastic. When the hydrostatic pressure is removed, the fluid end block tends to revert to its original configuration. However, the plastically deformed interior surface constrains this deformation. As a result, the interior surface of the fluid end block obtains a residual compressive stress layer.

Any suitable technique can be used to apply the coating layer. For example, in embodiments, the coating layer can be applied in situ by spraying the non-metallic material from an articulatable nozzle traversing through at least one of the chamber, the plunger passage, the intake passage, and the discharge passage. In embodiments, the method includes shot or grit blasting the area of the interior surface of the fluid end block that will have the coating layer applied thereto in order to create a rough surface that promotes the adhesion of the coating layer to the body.

In embodiments, the coating layer can be built up by applying successive coatings of the non-metallic material using multiple passes of the nozzle relative to the interior surface of the fluid end block. In embodiments, the width of a single pass of the nozzle can be varied by changing the nozzle configuration. Multiple, slightly overlapping, passes of the nozzle can be used to produce a continuous layer of the non-metallic material. In embodiments, the number of passes and the incremental distance between adjacent passes by the nozzle can be varied. Thus, a series of spraying passes by the nozzle can build up the coating layer of the non-metallic material to a desired thickness. Similarly, a series of spraying passes by the nozzle can be made to cover a desired surface area of the interior surface with subsequent spraying passes depositing the non-metallic material adjacent to, and overlapping, coatings from previous spraying passes. In embodiments, the deposition thickness produced by the moving nozzle can be varied based upon the material feed rate, the nozzle traverse speed, and the deposition efficiency. In embodiments, the nozzle can be manipulated by a robot arm. In embodiments, the control parameters of the application equipment can be varied to produce a desired layer of the non-metallic material. In embodiments, the operational parameters of the application equipment can be varied to achieve a layer of the non-metallic material suitable for its intended application.

In other embodiments, the coating layer can be in the form of an insert that is made separate from the body. Once the insert is set, the insert can be applied to the interior surface of the body by positioning the insert within the body at the desired location. In embodiments, the interior surface of the fluid end block can define one or more shoulder surfaces configured to mechanically interact with the coating layer in the form of a liner to help prevent relative motion between the body and the coating layer. In embodiments, the coating layer in the form of a liner can be sized such that an interference fit is created between the coating layer and the interior surface of the body to help retain the coating layer in place.

In embodiments, the interior surface of the fluid end block includes at least one threaded portion and a non-threaded portion. The coating layer can be applied such that the coating layer substantially covers the non-threaded portion. In embodiments, the coating layer substantially covers the chamber that is defined between the plunger passage, the intake passage, and the discharge passage.

In embodiments, the non-metallic material can be have an improved property relative to the base material of the body where the improved property can be selected based upon the expected environment of the remanufactured fluid end block when it is returned to service in its intended application. For example, in embodiments, the non-metallic material is selected to provide enhanced corrosion resistance relative to the base material. In embodiments, the non-metallic material comprises at least one of an epoxy and an elastomeric material, and the base material comprises a metal. In embodiments, the base material comprises a steel (such as a carbon steel, for example).

In embodiments of a method of remanufacturing a fluid end block following principles of the present disclosure, the fluid end block can be detailed to remove any overspray, for example. The remanufactured fluid end block can be cleaned. The remanufactured fluid end block can be gaged and inspected to verify that the remanufactured fluid end block is within the tolerance of the original specification. After meeting specification, the remanufactured fluid end block can be returned to service or forwarded to an inventory of interchangeable new fluid end blocks and remanufactured fluid end blocks.

In embodiments, the remanufactured fluid end block meets the dimensional specifications for the fluid end block prior to it being used. In embodiments, the coating layer of the non-metallic material can be disposed over a wear area that is oriented over a wear path associated with intended use of the remanufactured fluid end block.

Moreover, it will be understood that a method of remanufacturing a fluid end block following principles of the present disclosure can be generally applied to repair and remanufacture a variety of different types of fluid end block. Furthermore, although the illustrated embodiments describe a component in the form of a fluid end block, this is only exemplary, and in general, principles of the present disclosure can be applied to any type of component. It will be apparent to one skilled in the art that various aspects of the disclosed principles relating to remanufacturing can be used with a variety of different types of parts (such as, other parts subjected to corrosive materials, for example). Accordingly, one skilled in the art will understand that, in other embodiments, a method of remanufacturing following principles of the present disclosure can be applied to remanufacture different types of components and can take on different forms.

### INDUSTRIAL APPLICABILITY

The industrial applicability of the embodiments of well stimulation pump systems, fluid end block assemblies, and methods of remanufacturing fluid end blocks described herein will be readily appreciated from the foregoing discussion. Embodiments of well stimulation pump systems and fluid end block assemblies made following principles of the present disclosure can be used to deliver high-pressure fracturing fluid through a well bore to a subterranean hydrocarbon formation to fracture the rock. Oil and/or gas can then migrate to the wellbore through these fractures and significantly enhance well productivity.

As mentioned above, the fracturing fluid used for such operations can be corrosive. The continued cycling of the plunger(s) into and out of the chamber(s) of the fluid end of the well stimulation pump system, and the accompanied fluctuations between positive and negative pressure experienced by the interior surface of the body of the fluid end, can cause the fluid end to be susceptible to wet fatigue failure. Using principles of the present disclosure, in embodiments, a coating layer of non-metallic material that is more corrosion resistant than the base material from which the interior surface of the body of the fluid end is made can be applied to the interior surface of the body of the fluid end to increase the service time of the fluid end. Using principles of the present disclosure, a fluid end can be rebuilt or re-coated with a coating layer of non-metallic material in a remanufacturing process using principles of the present disclosure to further increase and/or renew the service time of the fluid end.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for the features of interest, but not to exclude such from the scope of the disclosure entirely unless otherwise specifically indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

What is claimed is:

1. A method of remanufacturing a fluid end block of a well stimulation pump, the method of remanufacturing comprising:
cleaning an interior surface of a body of the fluid end block, the interior surface being made from a base material, and the interior surface defining a chamber, a plunger passage in communication with the chamber, an intake passage in fluid communication with the chamber, and a discharge passage in fluid communication with the chamber;
cold-working the interior surface of the fluid end block to produce a compressive residual stress layer within the body;
applying a coating layer made from a non-metallic material to at least a portion of the interior surface of the body, the non-metallic material being different from the base material.

2. The method of remanufacturing according to claim 1, wherein the plunger passage of the fluid end block extends along a plunger axis, the intake passage extends along an intake axis, and the discharge passage extends along a discharge axis, the intake axis and the discharge axis each being substantially perpendicular to the plunger axis.

3. The method of remanufacturing according to claim 1, wherein cold working the interior surface of the body includes shot peening the interior surface.

4. The method of remanufacturing according to claim 1, wherein the interior surface of the fluid end block includes at least one threaded portion and a non-threaded portion, and wherein applying the coating layer includes substantially covering the non-threaded portion.

5. The method of remanufacturing according to claim 1, wherein applying the coating layer includes spraying the non-metallic material from an articulatable nozzle traversing through at least one of the chamber, the plunger passage, the intake passage, and the discharge passage.

6. The method of remanufacturing according to claim 1, wherein the body is made substantially from the base material.

7. The method of remanufacturing according to claim 1, wherein cleaning the interior surface of the body includes abrasive blasting the interior surface with a stream of abrasive media.

8. The method of remanufacturing according to claim 7, wherein the stream of abrasive media comprises glass beads.

9. The method of remanufacturing according to claim 1, wherein the non-metallic material comprises at least one of an epoxy and an elastomeric material.

10. The method of remanufacturing according to claim 9, wherein the base material comprises a metal.

11. The method of remanufacturing according to claim 9, wherein the base material comprises a steel.

12. The method of remanufacturing according to claim 1, further comprising:
repairing a crack in the body.

13. The method of remanufacturing according to claim 12, wherein repairing the crack includes welding the body.

14. The method of remanufacturing according to claim 13, further comprising:
machining the body to be within a tolerance range of a dimensional specification.

15. A fluid end block for a well stimulation pump, the fluid end block comprising:
a body, the body including an interior surface, the interior surface defining a chamber, a plunger passage in communication with the chamber, an intake passage in fluid communication with the chamber, and a discharge passage in fluid communication with the chamber, the interior surface being made from a base material, and the body including a compressive residual stress layer;
a coating layer, the coating layer being applied to at least a portion of the interior surface of the body, the coating layer being made from a non-metallic material, the non-metallic material being different from the base material.

16. The fluid end block according to claim 15, wherein the plunger passage of the fluid end block extends along a plunger axis, the intake passage extends along an intake axis, and the discharge passage extends along a discharge axis, the intake axis and the discharge axis each being substantially perpendicular to the plunger axis.

17. The fluid end block according to claim 15, wherein the interior surface of the fluid end block includes at least one threaded portion and a non-threaded portion, and wherein the coating layer substantially covers the non-threaded portion.

18. The fluid end block according to claim 15, wherein the non-metallic material comprises at least one of an epoxy and an elastomeric material.

19. The fluid end block according to claim 18, wherein the base material comprises a metal alloy.

20. A fluid end assembly for a well stimulation pump, the fluid end assembly comprising:
a body, the body including an interior surface, the interior surface defining a chamber, a plunger passage in communication with the chamber, an intake passage in fluid communication with the chamber, and a discharge passage in fluid communication with the chamber, the interior surface being made from a base material, and the body including a compressive residual stress layer;
an intake valve, the intake valve disposed within the intake passage of the body, the intake valve configured to selectively move between an intake closed position, in which the intake valve occludes the intake passage, and an intake open position, in which the intake valve permits fluid flow therethrough;
a discharge valve, the discharge valve disposed within the discharge passage of the body, the discharge valve configured to selectively move between a discharge closed position, in which the discharge valve occludes the discharge passage, and a discharge open position, in which the discharge valve permits fluid flow therethrough;
a plunger, the plunger disposed within the plunger passage such that the plunger is reciprocally movable over a range of travel including a suction stroke and a discharge stroke, the plunger drawing the intake valve to the intake open position to open the intake passage during the suction stroke, and the plunger moving the intake valve to the intake closed position to occlude the intake passage and moving the discharge valve to the discharge open position during the discharge stroke;
a coating layer, the coating layer being applied to at least a portion of the interior surface of the body, the coating layer being made from a non-metallic material, the non-metallic material being different from the base material.
